(19) United States
(12) Patent Application Publication
(10) Pub. No.: US 2005/0075852 A1
(43) Pub. Date: Apr. 7, 2005

(54) Dynamic design of hydraulic systems

(75) Inventor: Sten Lindberg, Helsingor (DK)

Correspondence Address: WILLIAM R. EVANS;c/o LADAS & PARRY, 26 WEST 61ST STREET, NEW YORK, NY, 10023, US

(73) Assignee: DHI WATER & ENVIRONMENT

(21) Appl. No.: 10/678,729

(22) Filed: Oct. 3, 2003

(51) Int. Cl. G06G 7/48

(52) U.S. Cl. 703/9

(57) ABSTRACT

The invention relates to a method of designing the geometrical size of a hydraulic element in a hydraulic system composed of hydraulic elements. The method has access to: a geometrical parameter representing geometrical size and shape of the hydraulic element and a flow resistance parameter representing flow resistance properties of the hydraulic element; and a numerical representation of simulated measures of the flow. The numerical representation of the hydraulic system is open to changes in a calculated flow capacity through changes in a value of the flow resistance parameter. The method comprises the steps of: simulating measures of the flow at discrete instances of time and at discrete instances of space of the hydraulic system; regulating a calculated value of the flow-capacity in response to a design criterion by adjusting the flow resistance parameter to obtain a regulated value of the flow capacity; and calculating the value of a geometrical size of the hydraulic element from the regulated value of the flow capacity and a specified flow resistance parameter. Additionally, the method relates to a computer system and a computer readable medium. Thereby the effect of numerical instabilities is avoided or at least diminished.

### FIELD OF THE INVENTION

This invention relates to the field of computer aided simulation or numerical modelling of fluids in pipes or channels. In a preferred embodiment, the invention relates to the field of hydroinformatics. Hydroinformatics addresses the application of computerized information technologies to the management of water environment and water engineering infrastructure especially by means of computer-implemented simulations.

### BACKGROUND OF THE INVENTION

In recent years, hydraulic engineers, hydrologists, and planners have used computer-implemented simulations of hydraulic systems to examine the behaviour of water in a system when it is exposed to specified internal or external events. A rather new discipline in hydroinformatics is the application of numerical models used for simulations as an aid in designing elements of a hydraulic system.

Physical elements of a hydraulic system include pipes, channels, man-holes, inlets, outlets, weirs, gates, culverts, tanks, reservoirs and regulators, which can be passive (eg an orifice from a reservoir to a pipe) or active (eg a pump or a movable gate).

Hydraulic systems are constructed in order to perform certain tasks, such as for conveying waste water from households to a treatment plant or for conveying natural gas from a pumping station to a consumer. The performance of a hydraulic system can be described in terms of physical properties such as flow volumes, levels of fluids or pressure of gasses. A hydraulic system is typically designed to perform within certain limits expressed through these physical properties, eg certain fluid levels which should not be exceeded. Some or all of these limits occur directly or indirectly as design criteria in a simulation.

A numerical model simulates the physical properties of a hydraulic system by solving equations, which describe the physical laws governing the behaviour of the hydraulic system. Numerical models can simulate systems which are operating without time variations (steady state models) as well as systems which are operating with changes over time in the physical properties (dynamic models). This invention relates to the application of dynamic numerical models of hydraulic systems.

Dynamic simulation models for hydraulic systems often require four different types of input data:
1. Geometrical Data: Data which represents a description of the physical elements of the hydraulic system (examples: pipe diameters, weir levels, roughness of the pipe material). Typically, geometrical data are incorporated in a numerical model that also represents the topology of a network of hydraulic elements to thereby represent a system of hydraulic elements.
2. Operational Data: Data which represents the operation of regulators in the hydraulic system. The operational data can be prescribed as time series of variations of a physical element (example: a level of a weir as a function of time) or it can be prescribed as operational rules, where a physical element varies as a prescribed function of a physical property of the hydraulic system (example: a pump which starts and stops as a function of a water level in a pump pit).
3. Initial Conditions: Data which represents a description of the physical properties throughout the entire hydraulic system at the start of the simulation (examples: flow velocities and fluid levels in each pipe and man hole)
4. Boundary Conditions: Data which represents the time variations during a simulation period of the physical properties at all points where the system interacts with the surroundings (examples: inflows to the system through a man-hole, fluid pumped out of the system at a pumping station)

Dynamic models of hydraulic systems can simulate the physical properties of the system at different levels of detail. Some models describe the full 3-dimensional pattern of flows in the hydraulic system (3D models). Other models use simplified descriptions, representing the flows in either two dimensions (2D) or a single dimension (1D). The choice of model depends on the specific problem to be simulated and on the computational resources and input data available. Regardless of the choice of model representation (1D, 2D or 3D) a dynamic simulation model often requires the four types of input data described above. And regardless of the choice of model representation, the natural laws which determine the performance of the hydraulic system are the same, but the specific equations which describe the physical properties of the fluid in the hydraulic system will be different depending on the choice of model.

Many simulation models used for practical engineering purposes related to the simulation of flows in hydraulic systems are using a 1D representation of the hydraulic system. If the hydraulic system is one that is used for the conveyance of water or another fluid (rather than a gas) and if the hydraulic system is operating under unpressurised or moderately pressurised conditions, then the vast majority of numerical models use the same basic equations to describe the flows in the system: These equations are known in literature as the Saint-Venant equations. Examples of systems which can be simulated based on this type of 1D dynamic models are many waste water systems, storm water systems and also many natural surface water systems (rivers).

The Saint-Venant equations are so-called hyperbolic differential equations which can be solved analytically for very simple systems only. Therefore the equations have to be solved numerically for all practical applications. Many different computer-implemented simulation tools, which solve the Saint-Venant equations using varying numerical methods, are being used by engineers in the analysis of hydraulic systems.

Numerical models are being used by engineers in the process of designing hydraulic systems. By designing is meant, in this context, selecting dimensions of the physical elements of the hydraulic system (geometrical data), which correspond to certain selected design criteria. Examples of design criteria for sewer systems and water distribution systems can be:

### EXAMPLE 1

The water level in manhole xx in the sewer system should not exceed level yy, when the system experiences a defined design event (eg defined in terms of the inflows generated by a design hydrograph).

### EXAMPLE 2

The pressure level at any fire hydrant in a water distribution system should not fall below a defined minimum value (design pressure) during normal operational situations.

For sewer systems, an engineer uses the numerical model to simulate the performance of the hydraulic system, using a so-called design rain to provide boundary conditions for the simulation model. A design rain is typically represented as samples over time of the amount of precipitation resulting from a given rain event. If the simulation shows that the design criteria are met, then the dimensions are acceptable and the design process is completed. If not, then the engineer—based on experience and engineering knowledge—will specify changes in the geometrical data, repeat the simulation and check if the design criteria are now met. This iterative process is feasible if the number of physical elements to be designed is small and system performance is only considered for a few locations in the hydraulic system under design. If the number of elements is larger and/or design criteria are more complex, then the number of possible combinations to be simulated quickly becomes unmanageable (combinatorial explosion). In such cases, the engineer will typically rely on simpler methods to obtain an estimated size for all elements and then use the simulation model to verify that the design criteria are met. The draw-back of the simpler methods is that they typically result in over-design—ie a far less than optimal design from an economic perspective.

### DESCRIPTION OF RELATED ART

A prior art design method is illustrated in FIG. 1. This prior art design method for design with numerical models includes two integrated loops:
An outer loop, which is continued or left in step 105, represents the iterative process of a complete simulation of the hydraulic behaviour of the hydraulic system in the period covered by the design rain; the loop involves manual change of the geometrical data as input for a next iteration;
An inner loop, which is continued or left in step 103, represents the simulation of the hydraulic behaviour of the hydraulic system over discrete instances of time.

The first step 101 in the prior art design method involves generation of a numerical representation 108 of the hydraulic system which is represented by geometrical data 109. The geometrical data 109 describes positions and internal connections of all the hydraulic elements of the system as well as size, shape and flow resistance of pipes, channels, manholes, inlets, outlets, weirs, gates, pumps, culverts, tanks, reservoirs etc.

The numerical representation 108 of the hydraulic system under design is used as a basis for simulating the hydraulic behaviour of the system. A second step 102 includes setup of initial conditions (110) describing the levels and flows in all hydraulic elements as well as state/position of active elements like pumps and movable gates.

The simulation is performed in step 102 by calculation of hydraulic conditions of levels and flows in all hydraulic elements in discrete time steps based on
the conditions from prior time step—initial conditions 110 or calculated conditions;
operational data 111 including e.g. rules for start-/stop of pumps, change in pump speed, movement of weirs and gates etc.
boundary conditions 112 including e.g. input of waste water and/or rain water, downstream water levels in outlets etc.

At each time step it is evaluated in step 103 whether the end of the simulation period is reached. If the end of the simulation period is not reached (N) the inner loop is reentered at step 102; alternatively (Y), the inner loop is stopped and the method continues to step 104 wherein the simulation is stopped.

If the simulation is stopped in step 104, the design criteria 113 are evaluated in step 105—this could typically be evaluated by manual comparison of a calculated level or flow with a limit which should not be exceeded (e.g. maximum level in a manhole in order to avoid flooding).

If, in step 105, it is determined that the design criteria are fulfilled (Y) the design process is ended in step 107. Alternatively (N), the geometrical size of the hydraulic element is manually changed in step 106 based on manual evaluation of the results and on experience and engineering knowledge in order to obtain the required flow capacity. Consequently a new iteration cyclus is started, thus the outer loop is re-started in order to evaluate the effects of the manual change of the size of the hydraulic element.

However, such a hydraulic numerical model is prone to become unstable if geometrical data change during simulations. This is particularly true if the changes—being automatic or manual—involve the addition or subtraction of volume (as for instance if a pipe diameter changes) or if it involves the introduction of discontinuities in fluid levels (as for instance if a pipe dimension of a partially full pipe is changed in a manner which keeps the total volume of fluid constant). Hence, it is not feasible to allow the model to modify such geometrical parameters during a simulation.

### BRIEF SUMMARY OF THE INVENTION

The overall object of the invention is to design a hydraulic system through interactive use of a simulation model which automatically modifies the model representation of the geometrical data during simulations. This allows the engineer to determine design values (sizes) which are economical (not over-designed) through a few iterative model simulations—even for complex hydraulic systems where many elements can be changed and many design criteria must be met.

The desired effect of a change in dimensions, ie a change in flow capacity, can be simulated in accordance with the invention by changing the representation of the resistance of the physical element towards the flow. In the simulation model, this can be accomplished by modifying the representation of the ROUGHNESS of the material of the physical element during the simulation ie during iterations of the simulation rather than by modifying the representation of the physical dimensions of the element. The advantage of this method is that it does not introduce sudden changes in volumes or levels, and hence is much less prone to numerical instabilities.

During each of the iterations the model automatically modifies the ROUGHNESS of those elements which are to be designed. After each iteration the changes in ROUGHNESS are automatically translated into equivalent changes in dimensions, ie changes which result in the same hydraulic resistances of the hydraulic elements.

The automatic change in the ROUGHNESS data during each of the iterations takes place for each time-step in the dynamic simulation. This automatic change is implemented in terms of a simulated PID regulator (Proportional, Integral and Differential regulator), which regulates the roughness. During each iteration, this corresponds to changing—typically increasing—the conductivity of the hydraulic elements (increasing the pipe diameters, if it is a pipe network).

In a dynamic hydraulic system, changes interact in complex feed-back loops. Increasing the capacity of one element may create capacity problems in other elements or the opposite: it may lead to over-capacity of some other elements. Hence, it is not possible to calculate the required capacity for each element in turn. Instead, a solution is found through an iterative process, where the elements are allowed to increase in capacity during iterations, but reduced in capacity by a user-selected fraction between the iterations. Through this process, feed-back loops are resolved and excessive over-design is avoided.

Tests show that the number of required iterations to reach a solution is small, even for quite large and complex hydraulic systems where many elements and many design criteria are involved.

The invention can be embodied in the form of a computer-implemented method of designing the geometrical size of a hydraulic element in a hydraulic system composed of hydraulic elements. In order to process information related to the hydraulic element, the method has access to: a geometrical parameter representing geometrical size and shape of the hydraulic element and a flow resistance parameter representing flow resistance properties of the hydraulic element; and a numerical representation of simulated measures of the flow. The numerical representation of the hydraulic system is open to changes in a calculated flow capacity through changes in a value of the flow resistance parameter eg a roughness parameter. The method comprises the steps of: simulating measures of the flow at discrete instances of time and at discrete instances of space of the hydraulic system; regulating a calculated value of the flow capacity in response to a design criterion by adjusting the flow resistance parameter to obtain a regulated value of the flow capacity; and calculating, the value of a geometrical size of the hydraulic element from the regulated value of the flow capacity and a specified flow resistance parameter.

The step of ‘regulating’ is alternatively embodied as a step of regulating a value of the flow resistance to obtain a regulated value of the flow capacity. In both embodiments of the step of ‘regulating’ a regulated value of the flow capacity is obtained by converting a value of the flow resistance to a value of the flow capacity under the condition that the size and shape of the hydraulic element as regards size and flow that affects the flow in the element remains unchanged over an iteration period. Thereby forms of the so-called Manning expression can be applied to calculate the flow capacity.

Typically, a simulation or design process is composed of multiple iteration periods. The length of an iteration period can be determined by the length of a sequence with samples of boundary or/and initial conditions. However, the iteration periods can be shorter, due to eg an interrupt of the iteration/simulation, or longer due to eg long time constants of the hydraulic system. In the latter case the iteration period can be determined to end when measures of the flow fulfils specified criteria.

### BRIEF DESCRIPTION OF THE DRAWINGS

The invention will be described in the following with a reference to the drawing in which:

FIG. 1 shows a prior art method of designing a hydraulic system;

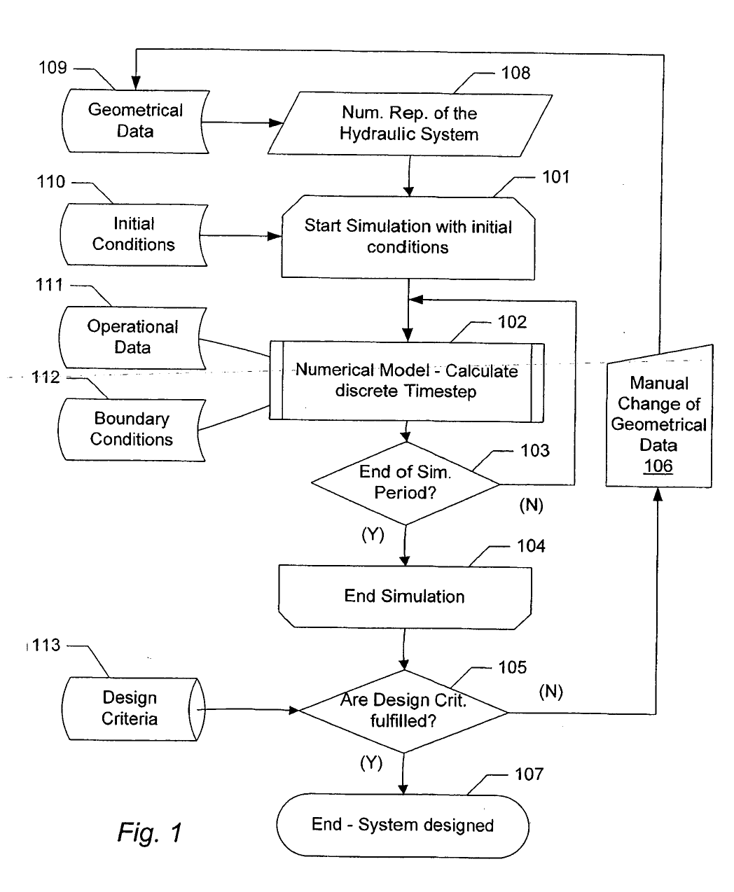

FIG. 2 shows the principle of the invention;

FIG. 3 shows a method of designing a hydraulic system according to the present invention; and

FIG. 4 shows a block diagram for an embodiment of a system arranged to design a hydraulic system.

### DETAILED DESCRIPTION OF THE INVENTION

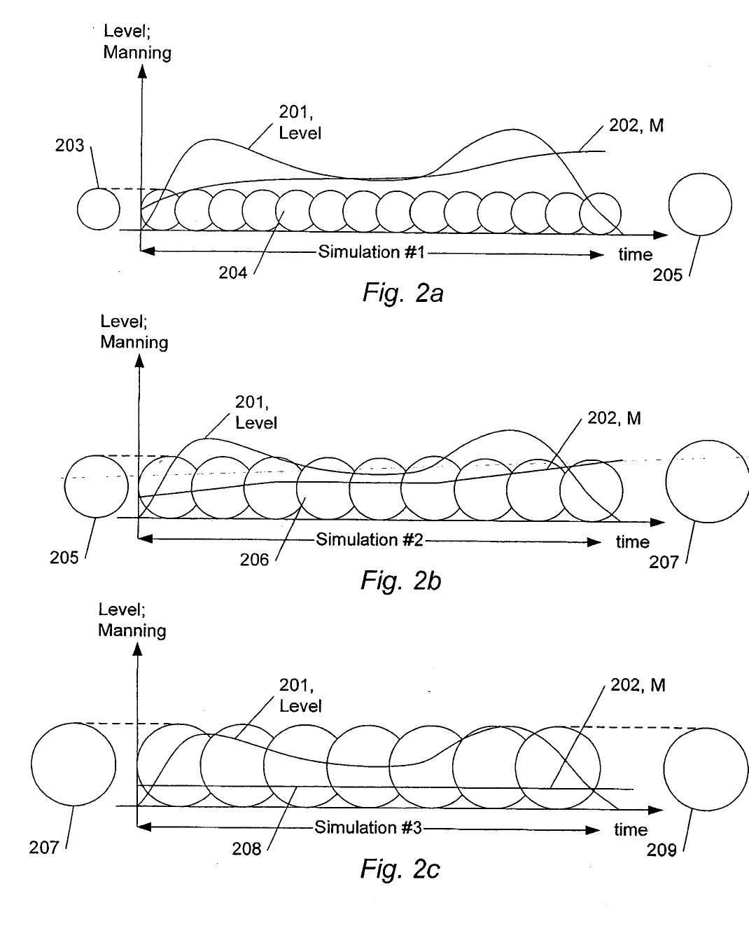

FIG. 2a, 2b and 2c show the principle of the invention. The invention is based on an iterative process where pipe diameters are changed in order to fulfil a specified design criterion. In the description of FIG. 2a, 2b and 2c it can be assumed that the design criterion is in the form of a maximum fluid level where the maximum fluid level is to not exceed a value of the pipe diameter. During each iteration, of in this illustration three iterations, the diameter is kept constant, but the Manning number is changed (typically increased) by a regulator during simulation if the criterion is not fulfilled.

FIG. 2a shows the level of a fluid at the given location in a hydraulic system where the design criteria is defined and a parameter M, representing the Manning number in the pipe that are subject for the design,—both as a function of time. The curve 201 shows how the level of the fluid at the given location develops over time or discrete instances of time for a first of the three iterations in a simulation. The curve 202 shows how the parameter M in the pipe develops over time as a consequence of being regulated according to the present invention. The parameter is regulated to compensate for an excessive fluid level. The aim of the regulator is to lower the fluid level by increasing the flow capacity of the pipe—other things being equal. But instead of regulating the size of the pipe to increase the flow capacity, the flow capacity is increased by regulating the flow resistance to a decreased value, which corresponds to an increase in the Manning number. Thus, the flow capacity is increased by increasing the value of a parameter representing the Manning number of the pipe around the given location. It should be noted that the fluid level may increase despite the flow resistance being lowered, since inflow and outflow to/from the given location also is determined by other parts of the element or system included in the simulation.

The circle 203 and the sequence of circles 204 illustrate that the simulation is started with a first pipe diameter which is held constant over the simulation period in simulation #1. The capacity of the pipe is artificially increased over the simulation period by decreasing the flow resistance, ie increasing the Manning number. However, when the simulation period has elapsed, a second pipe diameter is calculated. This second pipe diameter is calculated under the conditions that:
1. The pipe is to have a selected flow capacity which can be selected as a maximum value, achieved over the simulation period, #1, of the flow capacity. Typically, the selected value corresponds to a value achieved at the end of the simulation period.
2. The pipe is to have a selected flow resistance which can be selected as the flow resistance the simulation was started with, ie the initial flow resistance. Often the initial flow resistance is selected since it reflects the flow resistance of a commercially available element of a preferred material. However, without departing from the scope of the invention any other flow resistance than the initial can be selected.

The pipe corresponding to the second pipe diameter is illustrated by the circle 205.

Preferably, the flow capacity is calculated during a simulation period—eg at every time step—as a consequence of the flow resistance being regulated or changed. Therefore, the flow resistance or flow capacity is referred to as a regulated flow resistance or a regulated flow capacity. At the end of the iteration—after the simulation period—the flow capacity is calculated from the flow resistance given the condition that the geometrical size and shape of the hydraulic element remains constant over the iteration period. Thus, at the end of the simulation period the selected flow capacity is applied in combination with the selected flow resistance value to calculate a new dimension of the element yielding the same selected flow capacity but at the selected flow resistance.

The pipe diameter can be calculated from the Manning number (M), a specified geometrical slope (S) of the pipe, and the regulated value of the flow capacity (Q) in accordance with the following approximation:
Q=MAR^{2/3}\sqrt{S}
where:
Q is the flow capacity, M is Manning's number which represents the roughness of the material of the inside wall of the pipe or channel, A is the cross-sectional flow area of the pipe or channel, R is the hydraulic radius of the pipe or channel, S is the pipe slope of the pipe or channel. However, this will leave A and R unknown in the above approximation. If, however, the cross-sectional shape, eg being circular, of the pipe is known the pipe diameter can be calculated by expressions known in the art.

Consequently, a second pipe diameter 205 after a first iteration is provided.

FIG. 2b shows a second simulation period like the one shown in FIG. 2a, but here the simulation is started with a pipe diameter corresponding to the second pipe diameter 205. Hence, this second simulation period, #2, is based on the result of the prior simulation period shown in FIG. 2a. It can be seen that the fluid level has been lowered and that the fluid level is below the topmost portion of the pipe in a middle portion of the simulation period. Thus, it is not necessary to regulate the flow resistance or Manning parameter 202 in this part of the period. It can be seen that the second pipe diameter is held constant over the simulation period—this is illustrated by the sequence of circles 206. When the second simulation has elapsed, a third pipe diameter is calculated as described above.

Consequently, a third pipe diameter 207 after a second iteration is provided.

FIG. 2c shows a third simulation period where prior simulations have revealed a pipe diameter which is illustrated by the size of the circle 207. This pipe diameter is held constant over the third iteration period, #3, as illustrated by the sequence of circles 208.

It can be determined that the design criterion in the form of a maximum fluid level, where the maximum fluid level not may exceed a value of the pipe diameter 208, is fulfilled. Thus, it is not necessary to regulate the flow resistance or Manning parameter 202.

This latter one of the three simulations can verify that the design or size of the pipe 207 obtained in the former simulation fulfils the design criterion. Therefore it is not necessary to calculate a pipe size or diameter at the lapse of the third simulation. Hence, in this exemplary outcome the automatic simulation is completed after two iterations, where a final third iteration verifies the design achieved after the second iteration.

Consequently, a sufficient design of the pipe diameter is achieved.

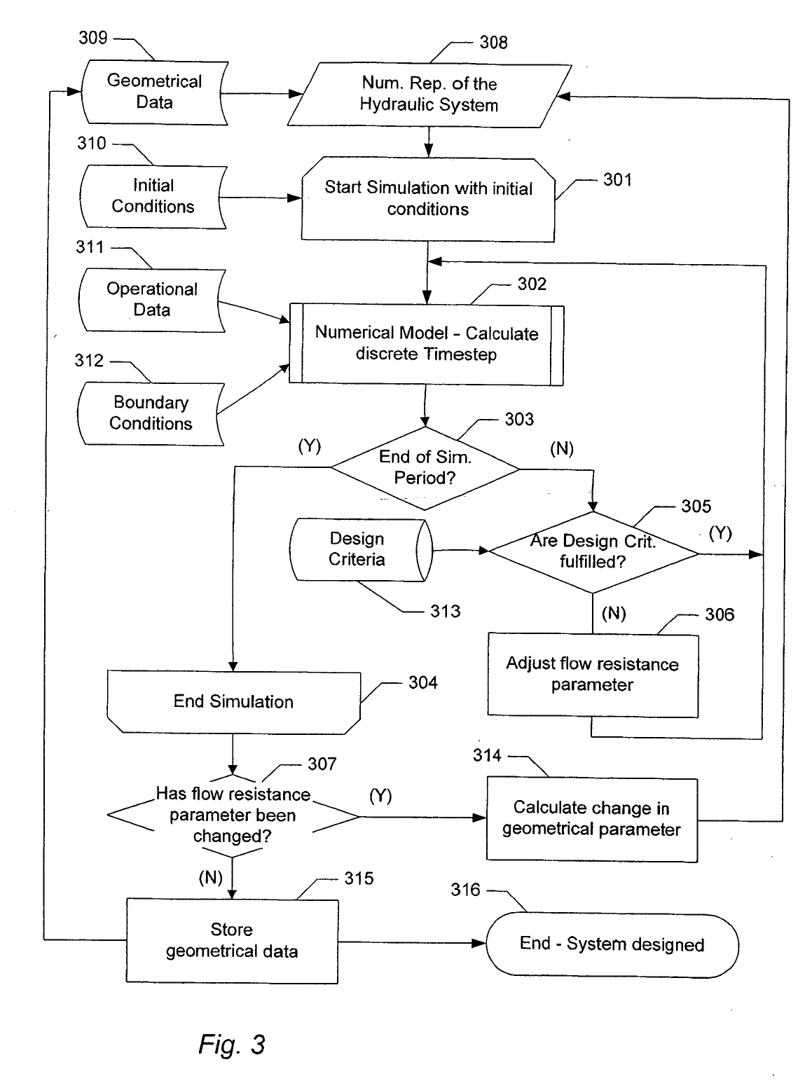

FIG. 3 shows a first method of designing a hydraulic system according to the present invention. The new methodology for design with numerical models includes two integrated loops:
An outer loop, which is continued or left in step 307, represents the iterative process of a complete simulation of the hydraulic behaviour of the hydraulic system in the period covered by the design rain; the loop involves calculation and update of a geometrical parameter as input for a next iteration;
An inner loop, which is continued or left in step 303, represents the simulation of the hydraulic behaviour of the system over discrete instances of time; this involves regulation of a calculated value of the flow capacity in response to a design criterion.

The first step 301 in the method involves generation of a numerical representation 308 of the hydraulic system which is represented by geometrical data 309. The geometrical data describes positions and internal connections of all the hydraulic elements if the system as well as size, shape and flow resistance of pipes, channels, manholes, inlets, outlets, weirs, gates, pumps, culverts, tanks, reservoirs etc.

The numerical representation 308 of the hydraulic system under design is used as basis for a simulation of the hydraulic behaviour of the system. The first step 301 includes setup of initial conditions 310 that describes the levels and flows in all hydraulic elements as well as state/position of active elements like pumps and movable gates.

In step 302 the simulation is performed by calculation of hydraulic conditions of levels and flows in all hydraulic elements in discrete time steps based on
the conditions from prior time step—initial conditions 310 or calculated conditions;
operational data 311 including e.g. rules for start-/stop of pumps, change in pump speed, movement of weirs and gates etc.;
boundary conditions 312 including e.g. input of waste water and/or rain water, downstream water levels in outlets etc.

At each time step it is evaluated in step 303 whether the end of the iteration period is reached.

If the end of the iteration period is not reached (N) the inner loop is re-entered at step 302 after an evaluation in step 305 of whether the design criteria 313 is fulfilled. In case the design criteria 313 are fulfilled (Y), the inner loop is re-entered directly. This outcome of the method reflects that no update of the design parameters is needed at this time instance of the simulation. However, in case the design criteria 313 are not fulfilled (N) a calculated value of the flow capacity is regulated in response to the design criterion by adjusting a flow resistance parameter 306 to obtain a regulated value of the flow capacity. This reflects that the flow capacity typically is a parameter that it is desired to monitor during the simulation. Alternatively, if the end of the simulation period is reached (Y) the inner loop is left at step 303 and the simulation is ended in step 304.

In step 307 it is tested whether the flow resistance parameter has been changed. If the flow resistance parameter has not been changed (N) the geometrical data 309 is stored in step 315. This reflects that the inner loop has terminated in step 303 without a change in the flow resistance parameter in step 306 ie the design criteria are fulfilled over the iteration period. Consequently, the result of the simulation, in the form of geometrical data, is stored and the design process ends—in step 316.

Alternatively, if whether the flow resistance parameter has been changed (Y) the corresponding change in the size of the geometrical parameter is calculated 314 and changed in the numerical representation of the hydraulic system 308. Consequently a new iteration cycle is started, thus the outer loop is re-started in order to evaluate the effects of the change of the size of the geometrical parameter.

From an overall algorithmic point of view, the step of regulating a calculated value of the flow capacity is performed over a finite period of time; and the step of regulating the calculated value is reiterated with the regulated value of the geometrical size, if a design criterion is not fulfilled. In accordance with the invention, the step of calculating a value of the geometrical size is performed when the step of simulating measures over the series of finite length has elapsed or when the step is otherwise terminated.

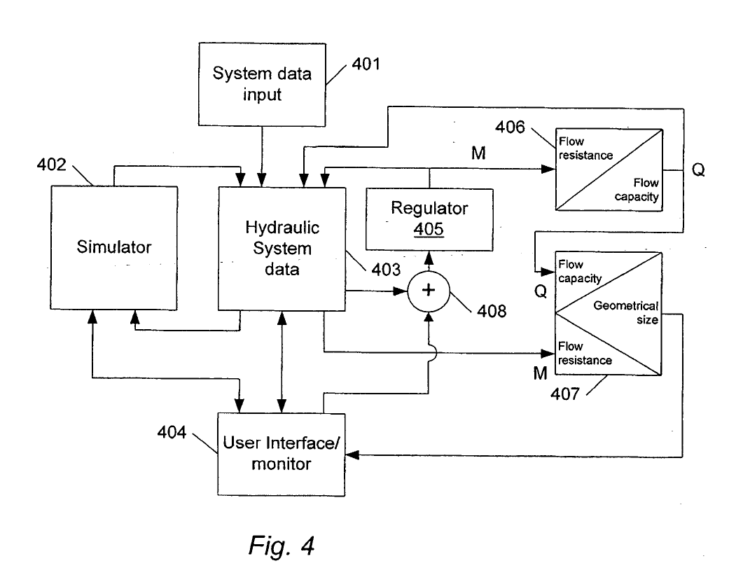

FIG. 4 shows a block diagram of an embodiment of a computer system arranged to design a hydraulic system. The computer system comprises a simulator 402 in the form of a computer program or computer-implemented method. The simulator is arranged to simulate measures of a flow in a hydraulic element that is encompassed in a hydraulic system. The hydraulic system is represented by geometrical parameters that represent geometrical size and shape of the hydraulic element and a flow resistance parameter representing flow resistance properties of the hydraulic element. The flow is represented by measures of the flow. The measures of the flow and the geometrical parameters are stored in data storage 403. This representation of the hydraulic system is open to changes in a calculated flow capacity through changes in a value of the flow resistance parameter. This means that a parameter or variable, stored the hydraulic system data storage 403, that represents flow capacity is updatable by writing a value received from the converter 406 to the parameter or variable. This update can be initiated by the converter 406 outputting a value in response to time step increment or a detected changed in the value of the flow resistance parameter that is input to the converter 406. In an alternative embodiment, the update can be initiated by simulator 402 or the data storage 403. However, it should be noted that other practical embodiments of this is possible without departing from the invention.

The simulator 402 is arranged to simulate measures of the flow at discrete instances of time and at discrete instances of space of the hydraulic system.

As a simulation is run over the discrete instances of time, the representation of the hydraulic system is open to changes in a calculated flow capacity through changes in a value of the flow resistance parameter, in this case the Manning number M. The flow resistance parameter, M, is regulated by the regulator 405. The regulator 405 regulates a calculated value of the flow capacity, Q, by means of the converter 406. The regulator operates in response to a design criterion evaluated by a comparator 408. Thereby, the flow resistance parameter is regulated to obtain a regulated value of the flow |capacity, Q, through the converter 406. The converter is preferably, arranged to convert a value at time steps of a simulation.

The regulator can be of the PID (Proportional, Integral and Differential) type, PI type, PD type, or other type. Hence, the value of the flow resistance parameter is regulated during simulations by means of a simulated regulator strategy.

Alternatively, the comparator 408 is an adder or difference calculator. Thereby, the value of the flow resistance parameter can be regulated in response to the difference between a value of the selected simulated measure and the design criterion.

When a simulation has elapsed or has been terminated otherwise, the converter 407 is applied to calculate the value of a geometrical size of the hydraulic element from the regulated value of the flow capacity, Q, and the flow resistance parameter, M. The flow resistance parameter M is loaded from the system data storage 403. The loaded flow resistance parameter has typically the same or substantially the same value as the value the simulation was started With. Optionally, however, another value can be loaded eg in response to an interaction with a use of the system via the user interface 404. Such another value can be loaded when another type of pipe or material the pipe is made from is selected for use through the (rest of the) simulation. For instance a pipe made from the material ‘concrete’ may be replaced by a pipe made from ‘plastic’. Thereby, size is traded for another material, which may be plastic—plastic is assumed to have a lower flow resistance.

When the hydraulic element is a pipe or channel the value of the geometrical size (A;R) is calculated by the converter 407 from the pipe or channel, a specified flow resistance, eg a roughness parameter (M), a specified geometrical slope (S) of the pipe or channel, and the regulated value of the flow capacity (Q) in accordance with the following equation:
Q=MAR^{2/3}\sqrt{S}

where: Q is the flow capacity, M is Manning's number which represents the roughness of the material of the inside wall of the pipe or channel, A is the cross-sectional flow area of the pipe or channel, R is the hydraulic radius of the pipe or channel, and S is the pipe slope of the pipe or channel the method having access to a procedure for determining the cross-sectional flow area and the hydraulic radius based on the size and shape of the pipe or channel. As mentioned above, if the cross-sectional shape of the pipe is known, the pipe diameter can be calculated by expressions known in the art. Thereby, the cross-sectional shape and size for a pipe with a sufficient flow capacity, which was found as a result of simulation, can be selected and calculated, respectively.

The converter 406 can operate under similar approximations/expressions as the converter 407 to calculate the flow capacity at a regulated/changed Manning number, but with an unchanged cross-sectional area and hydraulic radius. The converter 407 can be arranged to change the geometrical shape in addition or as an alternative to changing the geometrical size.

It should be noted that the regulator 405 provides a regulated value of the flow resistance parameter, M. The regulated value of the flow resistance parameter is converted to a regulated flow capacity by means of converter 406. The representation of the hydraulic system is open to these regulated values, which can be selected from a series of time instances of the regulated values.

A user interface 404 is preferably provided to control operation of the computer system arranged to design a hydraulic system. The user interface is not required, but is expedient for operating the simulator. Preferably, the user interface 404 is arranged to:
start and stop simulations;
selectively load data via a system data input 401 that provides the hydraulic system data to the data storage 403;
save results of a simulation ie among other things size and shape of hydraulic elements; and
select flow resistance values and flow capacity values for iterations, verifications of iterations, and final designs manually or depending on chosen preferences.

Additionally, the user interface 404 is arranged to monitor selected measures of a simulation eg graphically.

According to the invention the hydraulic system can be from any one of the following groups or the system can comprise elements from several of the following groups:
1. Wastewater systems;
2. Storm drainage systems;
3. Combined sewer systems;
4. Wastewater treatment facility hydraulic systems;
5. Irrigation systems.

These terms are well known to a person skilled in hydrology and computer systems for simulation/design of hydrology systems.

Generally, a design method according to the invention involves an iterative process that comprises one or more iteration steps; one iteration step comprises a (eg one) simulation that is run over a simulation period. A final iteration step can have the purpose of verifying that the design size obtained by previous iterations actually fulfils the design criteria over the entire simulation period. If an iteration step yields no change or only minor changes of the flow resistance parameter and consequently the flow capacity, the iteration can be determined to be a final iteration. Otherwise the iteration step can be followed by a further iteration step in which the iteration can be verified.

1. A computer-implemented method of designing the geometrical size of a hydraulic element in a hydraulic system composed of hydraulic elements; the method having access to:
a geometrical parameter representing geometrical size and shape of the hydraulic element and a flow resistance parameter representing flow resistance properties of the hydraulic element;
a numerical representation of simulated measures of the flow;
wherein the numerical representation of the hydraulic system is open to changes in a calculated flow capacity through changes in a value of the flow resistance parameter; the method comprising the steps of:
simulating measures of the flow at discrete instances of time and at discrete instances of space of the hydraulic system;
regulating a calculated value of the flow capacity in response to a design criterion by adjusting the flow resistance parameter to obtain a regulated value of the flow capacity; and
calculating the value of a geometrical size of the hydraulic element from the regulated value of the flow capacity and a specified flow resistance parameter.

2. A method according to claim 1, wherein the flow resistance parameter comprises roughness of the material of the hydraulic element.

3. A method according to claim 1, wherein the value of the geometrical size is calculated from the specified value of the flow resistance parameter, a value of the regulated value of the flow capacity, and specified geometrical shape and slope of the hydraulic element.

4. A method according to claim 3, wherein the hydraulic element is a pipe or channel and the value of the geometrical size (A;R) is calculated from the specified geometri cal shape (A,R) of the pipe or channel, a specified roughness parameter (M), a specified geometrical slope (S) of the pipe or channel, and the regulated value of the flow capacity (Q) in accordance with the following equation:
Q=MAR^{2/3}\sqrt{S}
where:
Q is the flow capacity,
M is Manning's number which represents the roughness of the material of the inside wall of the pipe or channel,
A is the cross-sectional flow area of the pipe or channel,
R is the hydraulic radius of the pipe or channel,
S is the pipe slope of the pipe or channel;
the method having access to a procedure for determining the cross-sectional flow area and the hydraulic radius based on the size and shape of the pipe or channel.

5. A method according to claim 1, wherein a simulated measure of the flow is selected from the group of: level of a fluid in the hydraulic element and/or flow rate of the fluid in the hydraulic element and/or pressure in the hydraulic element.

6. A method according to claim 1, wherein the value of the flow resistance parameter is regulated during simulations by means of a simulated PID (Proportional, Integral and Differential) regulator strategy.

7. A method according to claim 1, wherein the value of the flow resistance parameter is regulated in response to the difference between a value of the selected simulated measure and the design criterion in the form of a predefined threshold value.

8. A method according to claim 1, wherein the step of regulating a calculated value of the flow capacity is performed over a finite period of time; and
wherein the step of regulating the calculated value is reiterated with the regulated value of the geometrical size, if a design criterion is not fulfilled.

9. A method according to claim 1,
wherein the step of simulating measures is performed over a series of finite length; and
wherein the step of calculating a value of the geometrical size is performed when the step of simulating measures over the series of finite length has elapsed.

10. A method according to claim 1, wherein the hydraulic system is of at least one of the following groups:
Wastewater systems
Storm drainage systems.
Combined sewer systems
Wastewater treatment facility hydraulic systems.
Irrigation systems.

11. A method according to claim 1, wherein the numerical representation is a dynamic, one-dimensional model based on the solution of the Saint-Venant equations.

12. A computer-readable medium for making a computer execute the following method when run on a computer; the method having access to:
a geometrical parameter representing geometrical size and shape of the hydraulic element and a flow resistance parameter representing flow resistance properties of the hydraulic element;
a numerical representation of simulated measures of the flow;
wherein the numerical representation of the hydraulic system is open to changes in a calculated flow capacity through changes in a value of the flow resistance parameter; the method comprises the steps of:
simulating measures of the flow at discrete instances of time and at discrete instances of space of the hydraulic system;
regulating a value of the flow resistance to obtain a regulated value of the flow capacity; and
calculating the value of a geometrical size of the hydraulic element from the regulated value of the flow capacity and a specified flow resistance parameter.

13. A computer-implemented method of designing the geometrical size of a hydraulic element in a hydraulic system composed of hydraulic elements; the method having access to:
a geometrical parameter representing geometrical size and shape of the hydraulic element and a flow resistance parameter representing flow resistance properties of the hydraulic element;
a numerical representation of simulated measures of the flow; wherein the numerical representation of the hydraulic system is open to changes in a calculated flow capacity through changes in a value of the flow resistance parameter; the method compring the steps of:
simulating measures of the flow at discrete instances of time and at discrete instances of space of the hydraulic system; and
regulating a value of the flow resistance to obtain a regulated value of the flow capacity;
calculating the value of a geometrical size of the hydraulic element from the regulated value of the flow capacity and a specified flow resistance parameter.

14. A computer system for designing the geometrical size of a hydraulic element in a hydraulic system composed of hydraulic elements; the system comprising:
a data storage with a geometrical parameter representing geometrical size and shape of the hydraulic element and a flow resistance parameter representing flow resistance properties of the hydraulic element, and a numerical representation of simulated measures of the flow; wherein the numerical representation of the hydraulic system is open to changes in a calculated flow capacity through changes in a value of the flow resistance parameter;
simulator arranged to simulate measures of the flow at discrete instances of time and at discrete instances of space of the hydraulic system, a regulator arranged to regulate a value of the flow resistance to obtain a regulated value of the flow capacity, and a converter arranged to calculate a value of a geometrical size of the hydraulic element from the regulated value of the flow capacity and a specified flow resistance parameter.

15. A method according to claim 2, wherein the value of the geometrical size is calculated from the specified value of the flow resistance parameter, a value of the regulated value of the flow capacity, and specified geometrical shape and slope of the hydraulic element.
